(19) United States
(12) Patent Application Publication
(10) Pub. No.: US 2006/0004701 A1
(43) Pub. Date: Jan. 5, 2006

(54) System and method for adaptive decision making analysis and assessment

(76) Inventor: Charles F. Bacon, Evergreen, CO (US)

Correspondence Address: COCHRAN FREUND & YOUNG LLC, 2026 CARIBOU DR, SUITE 200, FORT COLLINS, CO, 80525, US

(21) Appl. No.: 11/027,011

(22) Filed: Dec. 30, 2004

Related U.S. Application Data
(60) Provisional application No. 60/533,343, filed on Dec. 30, 2003.

(51) Int. Cl. G06F 17/30

(52) U.S. Cl. 707/2

(57) ABSTRACT

Disclosed are a method and apparatus for fact collection and analysis whereby relevant facts can be used in multiple implementations to accomplish due diligence or decision making processes, and used for automated adaptive quantification, assessment, analysis, rating and scoring of due diligence or decision options for a business, entity or organization in a proactive and reactive manner. Due diligence or decision topics such as, but not limited to, mergers, acquisitions, debt or equity financings, strategic planning, risk assessments, audits of the processes of the organization including human resources, regulated activities, intellectual property, contracting and other business practices may benefit from the use and application of the system.

### CROSS REFERENCE TO RELATED APPLICATIONS

This application is based upon and claims the benefit of U.S. provisional application No. 60/533,343, entitled “Complex Emergent Assessment and Adaptive Bench Marking of Enterprise Analysis”, filed Dec. 30, 2003, the entire disclosure of which is hereby specifically incorporated by reference for all that it discloses and teaches.

### BACKGROUND OF THE INVENTION

a. Field of the Invention

The present invention relates generally to a system and method for decision analysis, and more specifically to the evaluation of information and assignment of metrics that are analyzed by computerized models to generate adaptive decision making assessments.

b. Description of the Background

The process of assessing key factors relevant to business decision making can be complex and fraught with inconsistencies and assumptions, and often contain the bias of the decision makers. Evaluations are historically performed without a norm, standard or business model, and without the benefit of scientific formula or method.

In the current business management arena, an accurate understanding of existing, historical and potential industry patterns and conditions is important. These factors, combined with general systems or business models and an up-to-date standard for selected parameters, are the basis of an effective analysis. Current business decision making tools fall short of full utilization of these factors. An additional problem with conventional decision making processes lies with the scope of the information considered and the imprecise and inconsistent manner in which analysis are performed.

Further weaknesses of conventional technology-based services include high costs, lengthy implementation times and high failure rates. These services are also limited in that they extract data without providing analysis, and organize data without making recommendations. During the 1990's many firms developed intelligent strategic planning systems that have since been abandoned because their output was inconsistent over time. This was due in part to the fact that the technology was not based on standards and rules that could consistently provide easily interpreted information.

### SUMMARY OF THE INVENTION

The present invention overcomes the disadvantages and limitations of the prior art by providing a system and method for fact collection so that relevant facts can be used in multiple implementations to accomplish due diligence or decision making processes and for providing a tool that allows for automated quantification, assessment, analysis, rating and scoring of due diligence or decision options for a business, entity or organization. Due diligence or decision topics such as, but not limited to, mergers, acquisitions, debt or equity financings, strategic planning, risk assessments, audits of the processes of the organization including human resources, regulated activities, intellectual property, contracting and other business practices all may benefit from the use and application of the system.

The process can be divided into major activities: information and factual input; execution and processing information to obtain useful interim or final results or condition status of the issue or concern under investigation in specified areas; comparison of the results or condition status to standardized values of the general relevant industry or activity as well as general systems or business models to gain an objective view or bench marking of a company or concern; and, analysis and generation of results including ratings useable by interested parties, reports or recommendations so as to quickly focus on the key issues and relationships with related topics or views. The historical condition of the same concern can also be used to illustrate changes in the company over time.

An embodiment of the present invention may therefore comprise a method for evaluating information, comprising the steps of: generating at least one module containing selected information in a chosen subject area, the at least one module including at least one metric from at least one source in the subject area; prompting a user of the at least one module for user information relating to the chosen subject area; adding the user information to the module; comparing the user information with the at least one metric to produce at least one score; and generating a report derived from the at least one score.

An embodiment of the present invention may further comprise an apparatus for evaluating information, comprising in combination: means for generating at least one module containing selected information in a chosen subject area, at least one module including at least one metric from at least one source in the subject area; means for adding user information relating to the chosen subject area to at least one module; means for comparing the user information with the at least one metric to produce at least one score; and means for generating a report derived from the at least one score.

These embodiments offer advantages over traditional so-called decision support systems. The described system is flexible, scalable and customizable for the type of decision that is being addressed. It is standards-based, with a set of minimum requirements for effective decision support processes that provides rapid and consistent results in an easy to use and cost-effective manner. The system will further extract and interpret data in a user-friendly manner and adaptively analyze and present data that is organized, easy to interpret and present.

### BRIEF DESCRIPTION OF THE DRAWINGS

In the drawings,

FIG. 1 is a block diagram of an embodiment for decision making analysis and assessment.

FIG. 2 illustrates a flowchart for the decision making analysis and assessment shown in FIG. 1.

FIG. 3 illustrates a flowchart of a module builder for the decision making analysis and assessment shown in FIG. 1.

FIG. 4 illustrates a flowchart of an analysis engine for decision making analysis and assessment shown in FIG. 1.

FIG. 5 illustrates a flowchart of a reports engine for decision making analysis and assessment shown in FIG. 1.

### DETAILED DESCRIPTION OF THE INVENTION

Although many embodiments of this invention are possible, there is shown in the drawings and will be described herein in detail specific embodiments thereof with the understanding that the present disclosure is to be considered as an exemplification of the principles of the invention and is not to be limited to the specific embodiments described.

The present invention includes a method and apparatus for collecting, sorting and filtering facts to which analytical tools are applied, and the results reported. As an example, a comprehensive information base may be developed for a business enterprise from which assessments and decision making can be facilitated.

A module or set of modules comprising information specific to a particular business or task is first created by gathering and organizing specific information from a variety of sources relevant to the subject or category. These modules may be accessed by a customer seeking assistance in the desired area or technology. A selected module is utilized as a basis for gathering additional information that is related to the decision or situation being investigated. That is, specific customer data input is requested by the module, as is information from a variety of other sources that pertain to the needs of the customer.

As an example, information relating to similar businesses or previous customer response data, a standards base (including business rules and boundary conditions) and a knowledge base are introduced into the module which allows scoring of the customer's business relative thereto. Returning to the example of a customer having interest in evaluating a business, specific information or data from a variety of sources may also include internal data relating to a business entity as well as data derived from other businesses. Examples of these types of data may include, but are not limited to, financial data, organization chart data, supply chain data, market data, regulatory data, environmental data, communication link data, human resources data, data relating to operations, data relating to products and services, data relating to technologies used in providing such products and services, and data relating to success or failure, at least some of which is used to create intermediate and final values for comparison to the standards, norms, or general systems or business models. Data analysis is then performed using logic or software algorithms, qualitative and quantitative comparisons, from which ratings and other evaluations of business decision options are generated. The results are communicated to the customer in text form and graphics, including normalized ratings. The ratings or scoring system is explained, and relevant support literature supplied. Recommendations may also be provided and out of boundary conditions may be flagged.

Analysis of customer response data thus may include data collection from multiple sources which are processed using algorithms and logic tools that may include but are not limited to benchmarking, pattern recognition analysis, adaptation, prioritization concept recognition, conceptual relationship analysis, arithmetic logic, symbolic rule induction, self-organizing data and information mapping, neural network analysis, decision tree classification, lexicon development, complexity analysis, and scoring key creation. These analyses may be performed using a computer based system that may comprise a single stand alone computer or PC as well as a series of linked (hardwire or wireless) computers or computer networks such as a local area network (LAN), wide area network (WAN) or the internet.

The results of the individual steps and processing may be stored and retrieved for further analysis or comparisons. It is therefore possible to refine comparisons and locate anomalies and deviations from expected results. The computer may store rules and equations for applications and logic tree paths that direct further analysis and later comparison with related standards. The logic tree paths, rules and equations can also be manually or adapted or updated by comparison with acquired data from numerous sources and related standards. Typically, a decision tree is used in a decision process with a set of available decisions that are subject to a series or set of tests that can be performed with known outcomes. The test outcomes are observed and a decision is made based upon these outcomes. Using a set of standards-based minimum requirements for effective decision support, the present invention provides rapid, consistent results in an easy to use and cost-effective manner. Quality checks may be performed at various points in the analysis.

In externally generated ratings, such as Standard & Poor's, Moody's or similar business ratings, the data subject to analysis focuses on financial data with most other available data being ignored. The present process evaluates an entity's environment in a comprehensive manner, rather than focusing on one aspect, thereby providing greater perspective and accuracy. Ratings generated in accordance with the present invention have the advantage that they are objective, and are based on foundations including generic minimum requirements/reference databases (GMR/RDB), standards and rules developed for each module, typically including acceptable response ranges derived from business rules. Analysis of the customer response data, therefore, provides a comparison of the results or condition status contained in the module and supplemented with customer input data and additional database information from general standards, general systems models or business models to thereby gain an objective view or bench marking of the decision situation.

The GMR/RDB may be combined with input from a variety of experts in the particular area pertaining to the module, including subject matter experts, business rules experts, technical, trade, legal, financial, public relations, sales, marketing or accounting experts, or a wide variety of experts in the particular field relevant to the subject matter of the module. The GMR/RDB includes specific subcategories that would be relevant to a module and can also be addressed by input from experts. Prompts for information from a user of the system to further define the scope and breadth of the decision to be solved along with specific details needed to tailor a decision to a specific circumstance, are included. Each item within the GMR/RDB may be assigned metrics from relevant businesses, and customer input is scored against these metrics. These may have natural ranges within each item, such as a 1-10 rating, or simply, a yes or no response. For example, if one wishes to decide whether to add a new piece of equipment or technology to a business unit, guidance would be provided in the form of a score or rating.

The particular data or decisions of interest will each have a set of facts to which the equations or algorithms will be applied. These in turn will yield the basis of the analysis to reach a result or grading of the options or topics that are of interest. The same facts and data may be useable for other analyses of due diligence or decision questions or topics. The system may anticipate this and adaptively conform the data format to be consistent with these analyses and to be accessible elsewhere in the system. Algorithm operations and steps as well as their products may be stored for multiple uses where appropriate.

Decision making and due diligence have many different applications and may be used, for example, in the purchase of an asset, hiring an employee, licensing a technology, acquiring a company, expanding a market, or strengthening a supply chain and the like. These terms may be used with evaluation of business models, building facilities, quantifying loans, interest rates, finance terms or cash flow.

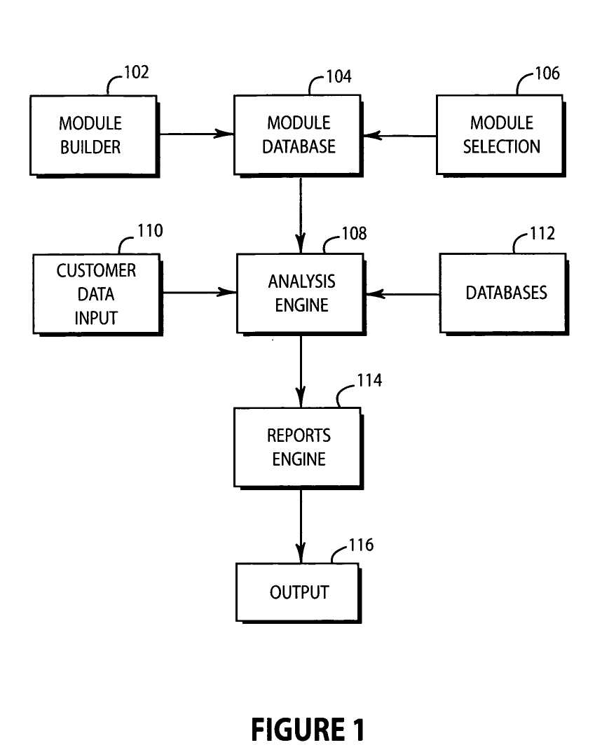

As illustrated in FIG. 1, an embodiment of a system and method for decision making analysis and assessment is detailed. The disclosed embodiment combines the ability to collect, sort and filter facts in useable form, to apply specified analytical tools to these facts, and to then report the findings in a clear and useable manner. Additionally, the embodiment allows the use of multiple types of artificial intelligence to create detailed examination that may include adaptive analysis such as content analysis, rule determination and logic tree determination. This analysis, for instance, is both proactive and reactive to current situations being analyzed and allows one to create, maintain, and update information within an organization, both internal and external to provide a comprehensive and consistent system of information for assessments and decision making.

Within this process a set of modules are created that are a collection of information specific to a particular business or task. These modules are created within the module builder 102 and stored for access in the module database 104 or module repository. A specific module is accessed by a customer seeking assistance in a particular area or technology by utilizing module selection 106 to parse the module database 104 for a matching module. Once a module selection 106 has been made, the specific module is loaded into the analysis engine 108. The analysis engine 108 utilizes the selected module as a basis for gathering additional information that may have direct relevance on the current decision or situation being contemplated. Customer data input 110 is sought in the form of a prompt for module data input that is adaptively generated within the selected module. In addition, a variety of outside sources of information may be accessed from databases 112.

These databases 112 may contain a variety of information from a variety of sources that pertain to the needs of the customer. These might include custom and subscription databases tailored to specific technologies and business areas or may include a variety of Internet and computer based information sources. The analysis engine 108 performs data analysis and in one embodiment a software algorithm allows for automated quantification, assessment, as well as rating and scoring of decision options for a business, entity or organization. A wide variety of decision topics and due diligence matters such as mergers, acquisitions, debt or equity financings, strategic planning, risk assessments, audits of the processes of the organization including human resources, regulated activities, intellectual property, contracting and other business practices and the like are subject to the use and application of the disclosed embodiments. Once the analysis engine 108 has performed its function, data is communicated to the reports engine 114 which generates reports in text form and graphics, including normalized ratings and produces a result as output 116.

The specific format of the output 116 is typically dictated by involvement with the desires of the reader or to comport with convention. Graphic representation may be used to show relationships between or among parameters and topics. An internally generated rating may be assigned to various aspects of the reports and may replace externally generated ratings, such as Standard & Poor's, Moody's or similar business ratings. These internally generated ratings are advantageous over external ratings because they are more objective based on foundations including Generic Minimum Requirements/Reference Databases (GMR/RDB), standards and rules, and entail more than a historical snapshot; and because they are based on expanded comprehensive data of the topic. As stated, in externally generated ratings such as Standard & Poor's, Moody's or similar business ratings, the analysis is focused on financial data, while other available data is largely ignored. The disclosed process is structured to evaluates an entity's environment in a comprehensive manner, rather than piecemeal thereby giving a greater sense of perspective and accuracy.

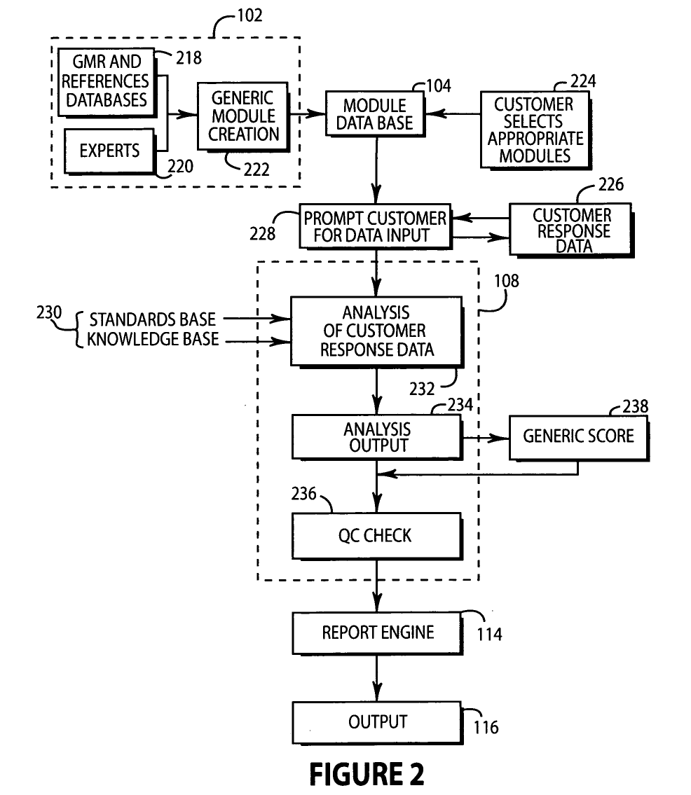

FIG. 2 is a detailed flowchart of a system and method for decision making analysis and assessment. In FIG. 2, the module builder 102 is used to create modules by taking and collating specific information from a variety of sources on a particular subject or category and compiling it into a discrete package (module). Modules can be created by utilizing input from Generic Minimum Requirements/Reference Databases data 218. This GMR/RDB 218 is combined with input from a variety of experts 220 in the particular area pertaining to the module. This expert input 220 may include subject matter experts, business rules experts, technical, trade, legal, financial, public relations, sales, marketing or accounting experts, or a wide variety of experts in the particular field relevant to the subject matter of the module. Utilizing a proactive and reactive module creation process, these inputs GMR/RDB data 218 and experts 220 are used for generic module creation 222. The GMR/RDB 218 includes appropriate and necessary specific subcategories that would be particularly relevant to a module and can also be addressed by input from experts 220. The GMR/RDB 218 forms a foundation for the main categories and generally accepted content within a module. The generic module creation 222 is initiated with the creation of a specific prompt for module data input by GMR/RDB 218 combined with experts 220 utilizing a module building tool. This tool assists in developing prompts for information that is provided by a user of the system to further define the scope and breadth of the decision to be solved along with specific details needed to tailor a decision to a specific circumstance. Each item within the GMR/RDB can be assigned metrics and scored accordingly. These may have natural ranges within each item, i.e., 1-10, yes/no etc. Specific customer input may also be included to create a new module or to further refine and develop a preexisting module. Within this system one can examine for instance, an entire company at the macro level and then specifically the micro level for a particular decision. If one is trying to make a decision about adding a new piece of equipment or technology to their existing network for example, a module may be selected or built that will help a customer understand their existing network and what that new piece of equipment or technology would do interactively for the old network.

The individual modules are then stored in a module database 104 where they can be accessed by a customer seeking assistance in decision making. The customer will then select an appropriate model 224 or suite of modules from the module database 104 where the customer is then prompted for data input 228. This prompt is typically in the form of a request for customer response data 226 presented to the customer comprising a number of requests for input specifically addressing the situation and individual needs relevant to the decision at hand.

This customer response data 226 is input back into the system and merged with the module information and transferred to the analysis engine 108. The analysis engine receives the information and adaptively performs an analytical analysis of the customer's response data 232 and applies additional input in the form of additional or previous customer response data, a standards base and a knowledge base 230. These additional sources of information may originate from internal databases, external databases as well as web based or Internet information sources. The analytical analysis of customer response data 232 includes data collection from multiple sources, data processing and a collection of algorithms and logic tools that may include but is not limited to benchmarking, pattern recognition analysis, adaptation, prioritization concept recognition, conceptual relationship analysis, arithmetic logic, symbolic rule induction self-organizing data and information mapping, neural network analysis, decision tree classification lexicon development rubric or scoring key creation and the like. This analysis engine may be driven by a computer based system of hardware that may comprise a single stand alone computer or PC as well as a series of linked (hardwire or wireless) computers or computer networks such as a local area network (LAN), wide area network (WAN) or the internet.

The overall goal of the analytical analysis of the customer response data 232 is a comparison of the results or condition status that is contained in the module and supplemented with customer input data and additional database information to general standards, general systems models or business models to thereby gain an objective view or bench marking of the decision situation. The particular data or decisions of interest will each have a set of facts upon which particular equations or algorithms will be applied. These in turn will yield the basis of the analysis to reach a result or grading of the options or topics that are of interest. The same facts and data may be useable in many different segments for different due diligence or decision questions or topics. The system can react and anticipate this and proactively make the data entry and format consistent and accessible across all aspects of the system. Additionally algorithm operations and steps as well as their products may be stored for multiple uses where appropriate.

The analysis of the customer response data 232 generates an analysis output 234 which is a culmination of any or all the analytical comparisons mentioned above to the specific problem or situation facing the customer. The analysis output 234 generates a generic score 238 which can be used to give rating of the major and sub-categories and specific items within the analysis. A quality check 236 may be performed at this time to perform a preliminary study of the analysis output 234 and the generic score 238 and determine if the score and output are as what would be expected and match possible preliminary or quality assurance criteria. The output is then directed to the report engine 114 where the data is made presentable and reports and information may be normalized in a universal fashion so as to be easily understood by persons in varying disciplines with varying backgrounds and viewpoints. The results and products of the above described steps and algorithms can also be stored and retrieved for further analysis or comparisons. Thus it is thereby possible to later refine comparisons and to locate the contributors to deviations or anomalies. The final output 234 may take a variety of forms including either text, graphics, multimedia or any combination thereof.

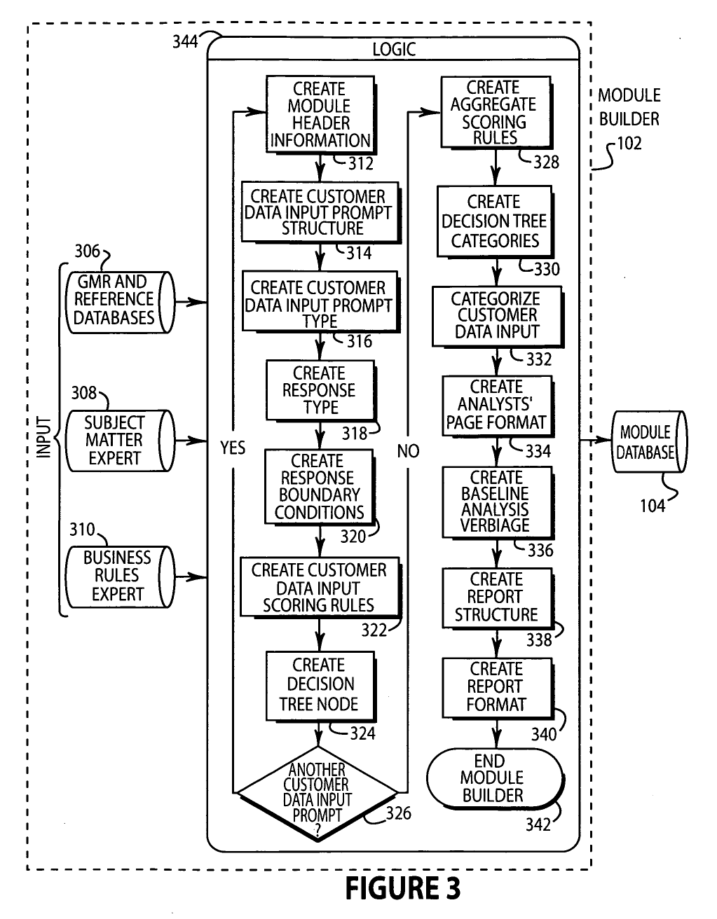

FIG. 3 illustrates a detailed flowchart of a module builder 102 utilized for decision making analysis and assessment. When a new module needs to be created, a subject matter expert 308 uses a reference database and GMR/RDB 306 which may comprise glossaries and ontologies, standards databases and/or knowledge databases and the existing module database 104 to begin the process and drive the module builder logic 344. The module header information is created with step 312 which may include information such as the name of the module, the type of module, the author, etc.

The create customer data input prompt structure step 314 is then determined and the appropriate editor is brought online followed by the step of create customer data input prompt 316. The data input prompt verbiage is entered into the chosen format and step create response type 320 is executed. This response type may be a word, sentence, paragraph, essay, radio button, multiple choice, or upload. The next step is to create response boundary conditions 320. The boundary conditions are codified by the GMR/RDB 306, subject matter expert 308 and the business rules expert 310 and are typically the acceptable response ranges backed by business rule definitions. The score for potential responses, as constrained by the boundary conditions, is codified into the business rules in step create customer data input scoring rules 322.

Once step 322 is completed, the customer data input is inserted into a decision tree as a node in step create decision tree node 324 and the base navigation rules are created at this time. Typically, a decision tree is used in a decision process with a set of available decisions that are subject to a series or set of tests that can be performed with possible outcomes. These outcomes are observed and a decision is made based upon these outcomes. Steps 312 through 324 are repeated as necessary as outlined in decision step another customer data input prompt 326 until all customer data input prompts have been created. If all of the customer data input prompts have been created and the response to step 326 is yes, the additional scoring rules for customer data input aggregates are created in step 328. Appropriate categories levels are developed in the decision tree step 330 and customer data input nodes in the decision tree are placed into the newly developed categories and additional rules are created for aggregations of responses in the step categorize customer data input 332.

Next, an analyst's page format is created in step 334. The customer data input and their responses will typically appear on the left side of a page along with an auto generated score (when the module is executed). The business rules that govern the analysis verbiage are generated in step 336 where analysis verbiage is created and subsequently linked to the business rules created in step 334. At this point the basic structure of a final report is created in step 338 and a final format of the final report is created on the basic structure at step 340 and the module builder ends at step 342. Typically, all of the details in steps 312 through 340 are stored in the module database 104 and are ready for use thereafter.

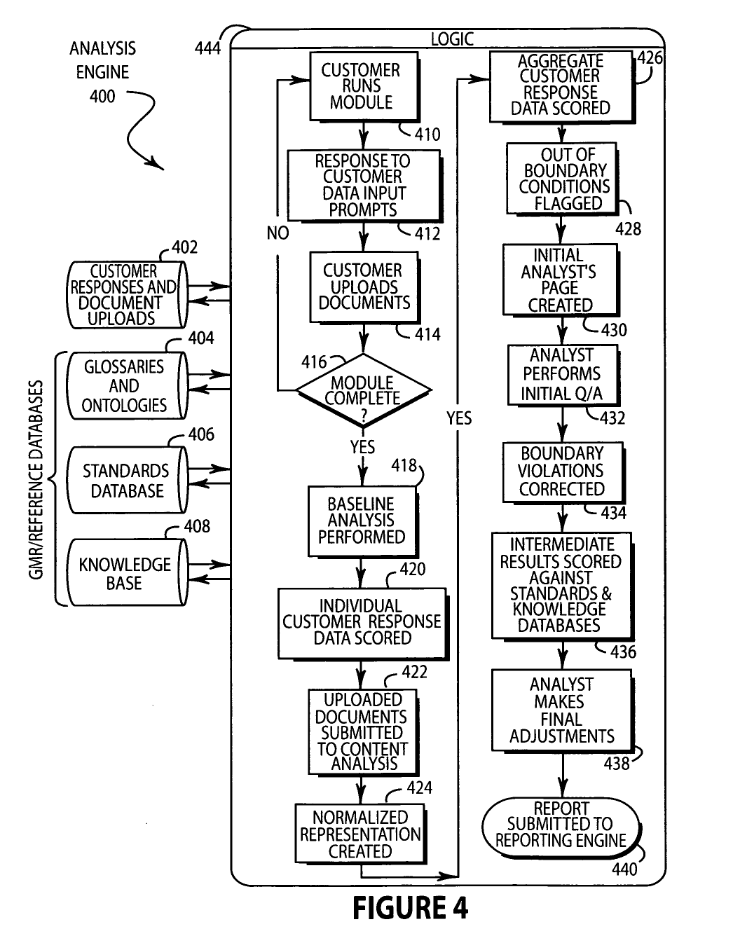

FIG. 4 illustrates a detailed flowchart of an analysis engine 400 utilized for decision making analysis and assessment. In the foregoing example a series of steps to provide analysis are performed in a web based or Internet interface although such a limitation is not explicit. For example a customer would log onto a website where they would be authenticated and proceed to an initial step where the customer runs a module 410 for a specific decision to be analyzed. The customer then responds to customer data input prompt to the best of their ability in step 412. In addition to the responses of step 412, documents or required electronic documents may be uploaded where appropriate and stored in customer responses and document uploads 402. This allows the execution of the module to have the option of being completed in a single session or spread over many sessions as may be convenient.

Additional responses to customer data input prompts are handled by repeating steps 410-416 until data input prompts have been addressed and a module is complete in step 416 and the module is marked as ready for analysis. Utilizing the reference databases and of the business rules and boundary conditions defined in the module database, a baseline or preliminary analysis is performed in step 418 and an analyst page is populated with scoring and report verbiage recommendations. As a part of this process, all individual customer response data are scored at step 420 and the uploaded documents are adaptively processed by the content analysis engine and the resulting data that has been analyzed and described with grammatical structure (parsed), are analyzed against the standards database and the module business rules and boundary conditions in step 422. The parsed data is put into a format compatible with the analysis and reporting engines in step 424, normalized representation created, and an aggregate customer response data scoring is performed in step 426. Out of boundary conditions (data defined to be beyond the norm or expected value) are flagged in step 428 and an analyst's page is created in step 430.

Once the analyst's page is completed and displayed, an analyst having expertise in the area of the subject matter of the customer and training in the operations of the decision making analysis and assessment system performs an initial quality assurance in step 432. The analyst will review and correct out of boundary conditions or violations in step 434 and a corrected report may be subjected to intermediate scoring against standards and knowledge databases 406-408 or glossaries and ontologies 404 or even subjected to the analysis engine again (not shown) to ensure compliance with standards, business rules, and boundary conditions. Once these steps are completed, an analyst makes final adjustments if any in step 438 and final analyzed report data is stored and submitted to the reporting engine at step 440.

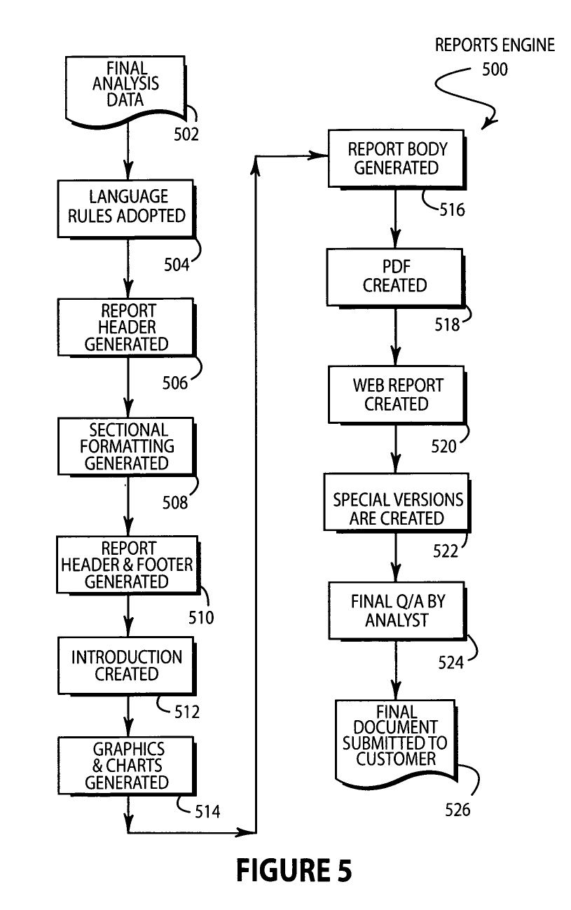

FIG. 5 illustrates detailed flowchart of a reports engine 500 utilized for decision making analysis and assessment. Once a set of final reports data is received into the reports engine at step 502 natural language processing (if necessary) may be performed on the final data in step 504. A report header is then generated in step 506 and sectional formatting appropriate to the module's content is generated in step 508. A report footer is accordingly generated in step 510 followed by a creation of an introduction in step 512. Graphics and charts are generated in step 514 combined with a generated report body in step 516.

This format may then be subjected to a universal display format such as a PDF in step 518 and a web report or HTML version of the final report is generated in step 520. Additional special versions and formats may also be created in step 522 as needed for specific customer platforms or needs before a final review of the report for a quality check by an analyst in step 524. The final finished product may take the form of a document that is submitted to the customer in step 526.

As mentioned above an embodiment may take the form of a software program (standalone, networked, internet based, server based or the like) to address the above stated objects and accomplishes of the decision making tasks. This computerization provides the power of advanced computational analysis and storage of input representing an organization in various relevant parameters. The databases store information and make it available by the individual steps or algorithms used in a variety of the multiple analytical topics mentioned. The results and products of the individual steps and algorithms are also stored and retrievable for further analysis or comparisons. Thus, it is possible to refine comparisons and locate contributors to anomalies and deviations from expected results. The computer can store rules and equations for applications and logic tree paths that direct further analysis and later comparison with related standards. The logic tree paths, rules and equations can also be manually adapted or updated by comparison with acquired data from numerous sources and related standards.

The embodiments detailed above, offer numerous advantages over traditional decision support systems. The described system is flexible, scalable and customizable for the type of decision that is being addressed. It is standards-based, with a set of minimum requirements for effective decision support processes that provides rapid, consistent results in an easy to use and cost-effective manner. The system will extract and interpret data in a user friendly manner and analyze and present data that is organized, easy to interpret and present.

These detailed embodiments are able to leverage the power of software and other technologies with human interaction to guide the user through the evaluation and decision-making process. These processes are readily applicable and useful in human-based services such as professional services (legal, accounting, management consulting, etc.) or in-house support (typically a matrix organization within large enterprises involving legal, accounting and other specialists, triggered by special assessment needs) or the like. Technology-based services (hardware/software/networks) are also applicable to this system and can be beneficial in the areas of business performance management, enterprise resource planning, executive information systems, data warehouses/data marts/databases, “how to” software and publications and the like. Additionally, the system can be utilized for technology or professional data gathering and intelligence.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for evaluating information, comprising the steps of:
generating at least one module containing selected information in a chosen subject area, the at least one module including at least one metric from at least one source in the subject area;
prompting a user of the at least one module for user information relating to the chosen subject area;
adding the user information to the module;
comparing the user information with the at least one metric to produce at least one score; and
generating a report derived from the at least one score.

2. The method of claim 1, further comprising the steps of changing the user information in the module to produce new user information, and comparing the new user information with the at least one metric to produce at least one second score.

3. The method of claim 2, wherein said steps of changing the new user information and comparing new user information are repeated until a desired at least one second score is obtained.

4. The method of claim 1, wherein the chosen subject area comprises business, and wherein the selected information comprises financial data and non-financial data, the non-financial data comprising at least one of: information relating to businesses similar to that of the user, previous user response information, business rules, business boundary conditions, organization chart data, supply chain data, market data, regulatory data, environmental data, communication link data, human resources data, data relating to operations, data relating to products and services, data relating to technologies used in providing such products and services, and data relating to business success or business failure.

5. The method of claim 1, wherein said at least one module is part of a database.

6. The method of claim 1, wherein said step of comparing is performed using a computer.

7. The method of claim 6, wherein the algorithms are selected from the group consisting of benchmarking, pattern recognition analysis, complexity analysis, automatic adaptation, prioritization concept recognition, conceptual relationship analysis, arithmetic logic, symbolic rule induction, self-organizing data and information mapping, neural network analysis, decision tree classification, lexicon development, and scoring key creation, are used by the computer in said step of comparing.

8. The method of claim 6, wherein the computer is selected from the group consisting of stand alone computers, linked computers, and a computer network.

9. The method of claim 8, wherein the computer network comprises a local area network.

10. The method of claim 8, wherein the computer network comprises a wide area network.

11. The method of claim 8, wherein the computer network comprises the internet.

12. The method of claim 1, further comprising the step of using the report to generate a decision-making assessment.

13. An apparatus for evaluating information, comprising in combination:
means for generating at least one module containing selected information in a chosen subject area, said at least one module including at least one metric from at least one source in the subject area;
means for adding user information relating to the chosen subject area to said at least one module;
means for comparing the user information with the at least one metric to produce at least one score; and
means for generating a report derived from the at least one score.

14. The apparatus of claim 13, further comprising means for changing the user information in said module to produce new user information, and means for comparing the new user information with the at least one metric to produce at least one second score.

15. The apparatus of claim 13, wherein the chosen subject area comprises business, and wherein the selected information comprises financial data and non-financial data, the non-financial data comprising at least one of: information relating to businesses similar to that of the user, previous user response information, business rules, business boundary conditions, organization chart data, supply chain data, market data, regulatory data, environmental data, communication link data, human resources data, data relating to operations, data relating to products and services, data relating to technologies used in providing such products and services, and data relating to business success or business failure.

16. The apparatus of claim 13, wherein said at least one module is part of a database.

17. The apparatus of claim 13, wherein said means for comparing comprises a computer.

18. The apparatus of claim 17, wherein said computer uses algorithms selected from the group consisting of benchmarking, pattern recognition analysis, complexity analysis, automatic adaptation, prioritization concept recognition, conceptual relationship analysis, arithmetic logic, symbolic rule induction, self-organizing data and information mapping, neural network analysis, decision tree classification, lexicon development, and scoring key creation.

19. The apparatus of claim 17, wherein said computer is selected from the group consisting of stand alone computers, a plurality of linked computers, and a computer network.

20. The apparatus of claim 19, wherein said computer network comprises a local area network.

21. The apparatus of claim 19, wherein said computer network comprises a wide area network.

22. The apparatus of claim 19, wherein said computer network comprises the internet.

23. The apparatus of claim 13, wherein the generated report is used to generate a decision-making assessment.

24. A method for evaluating business information, comprising the steps of:
generating at least one module comprising financial data and non-financial data, the non-financial data comprising at least one of: information relating to businesses similar to that of the user, previous user response information, business rules, business boundary conditions, organization chart data, supply chain data, market data, regulatory data, environmental data, communication link data, human resources data, data relating to operations, data relating to products and services, data relating to technologies used in providing such products and services, and data relating to business success or business failure, the at least one module including at least one metric from at least one source in the subject area;
prompting a user of the at least one module for user information relating to the chosen subject area;
adding the user information to the module;
comparing the user information with the at least one metric to produce at least one score; and
generating a report derived from the at least one score.

25. The method of claim 24, further comprising the steps of changing the user information in the module to produce new user information, and comparing the new user information with the at least one metric to produce at least one second score.

26. The method of claim 25, wherein said steps of changing the new user information and comparing new user information are repeated until a desired at least one second score is obtained.

27. The method of claim 24, wherein said at least one module is part of a database.

28. The method of claim 24, wherein said step of comparing is performed using a computer.

29. The method of claim 28, wherein the algorithms are selected from the group consisting of benchmarking, pattern recognition analysis, complexity analysis, automatic adaptation, prioritization concept recognition, conceptual relationship analysis, arithmetic logic, symbolic rule induction, self-organizing data and information mapping, neural network analysis, decision tree classification, lexicon development, and scoring key creation, are used by the computer in said step of comparing.

30. The method of claim 28, wherein the computer is selected from the group consisting of stand alone computers, linked computers, and a computer network.

31. The method of claim 30, wherein the computer network comprises a local area network.

32. The method of claim 30, wherein the computer network comprises a wide area network.

33. The method of claim 30, wherein the computer network comprises the internet.

34. The method of claim 24, further comprising the step of using the report to generate a decision-making assessment.

35. An apparatus for evaluating business information, comprising in combination:
means for generating at least one module comprising financial data and non-financial data, the non-financial data comprising at least one of: information relating to businesses similar to that of the user, previous user response information, business rules, business boundary conditions, organization chart data, supply chain data, market data, regulatory data, environmental data, communication link data, human resources data, data relating to operations, data relating to products and services, data relating to technologies used in providing such products and services, and data relating to business success or business failure, the at least one module including at least one metric from at least one source in the subject area, said at least one module including at least one metric from at least one source in the subject area;
means for adding user information relating to the chosen subject area to said at least one module, wherein the user information comprises financial data plus other information;
means for comparing the user information with the at least one metric to produce at least one score; and
means for generating a report derived from the at least one score.

36. The apparatus of claim 35, further comprising means for changing the user information in said module to produce new user information, and means for comparing the new user information with the at least one metric to produce at least one second score.

37. The apparatus of claim 35, wherein said at least one module is part of a database.

38. The apparatus of claim 35, wherein said means for comparing comprises a computer.

39. The apparatus of claim 38, wherein said computer uses algorithms selected from the group consisting of benchmarking, pattern recognition analysis, complexity analysis, automatic adaptation, prioritization concept recognition, conceptual relationship analysis, arithmetic logic, symbolic rule induction, self-organizing data and information mapping, neural network analysis, decision tree classification, lexicon development, and scoring key creation.

40. The apparatus of claim 38, wherein said computer is selected from the group consisting of stand alone computers, a plurality of linked computers, and a computer network.

41. The apparatus of claim 40, wherein said computer network comprises a local area network.

42. The apparatus of claim 40, wherein said computer network comprises a wide area network.

43. The apparatus of claim 40, wherein said computer network comprises the internet.

44. The apparatus of claim 35, wherein the generated report is used to generate a decision-making assessment.
